(19) United States
(12) Patent Application Publication
(10) Pub. No.: US 2008/0236227 A1
(43) Pub. Date: Oct. 2, 2008

(54) DRY LAND EROSION CONTROL USING PHOTOSYNTHETIC NITROGEN-FIXING MICROORGANISMS

(76) Inventor: Timothy M. Flynn, (US)

Correspondence Address: PRIMORDIAL SOLUTIONS, 463 GUNNISON AVE., SUITE # 2, GRAND JUNCTION, CO, 81501, US

(21) Appl. No.: 11/695,591

(22) Filed: Apr. 2, 2007

(51) Int. Cl. C05F 11/08

(52) U.S. Cl. 71/7

(57) ABSTRACT

In mesic environments, erosion control measures usually employ the establishment of vegetative cover by vascular plants in order to hold the soil in place. The current art often includes the application of seeds, chemical fertilizers, tackifiers, and mulches to promote the growth of vascular plants. However, arid environments so not support dense vegetative cover, but are instead dominated by photosynthetic microorganisms, primarily cyanobacteria and lichens. The cyanobacteria not only hold the soil in place, but also are the primary source of fixed nitrogen in arid environments. Disclosed herein, is a description of an apparatus and methods for the production and preservation of a photobiofertilizer as a means for repairing disturbed arid soils.

### FIELD OF THE INVENTION

The present invention relates to a method and means for the mass production, preservation, and application of terrestrial cyanobacteria to be used as a photosynthetic nitrogen-fixing biofertilizer. This invention performs three major functions: 1) it is a living photosynthetic fertilizer, 2) erosion control agent, and 3) sequesters carbon in harsh arid environments. The invention also has the benefits of reducing the energy consumption and pollution associated with the use of chemical fertilizers in modern agricultural practices. The invention has application to the reclamation of disturbed and agricultural landscapes, including mine reclamation, soil remediation and agricultural fertilizers.

### BACKGROUND OF THE INVENTION

As pressures from population and extractive industries increasingly impact the soils of arid regions throughout the world, it becomes clear that an improved approach is needed to repair these affected ecosystems. Traditional approaches usually rely on establishing vegetative cover in order to hold the soil in place. However, this approach achieves, at best, only limited success in arid environments because these ecosystems are dry, and as expected, can only support low density plant communities. In contrast, as summarized below, photosynthetic microorganisms, primarily cyanobacteria, dominate the living cover in arid environments. These terrestrial cyanobacteria not only carry the major burden of erosion control, but also determine biogeochemical cycles with respect to nitrogen, carbon and micronutrients. In this disclosure, we will provide a means for manipulating terrestrial photosynthetic microorganisms in order to reduce erosion and improve the fertility of arid and semiarid soils.

Throughout the World, cyanobacteria, lichens, bacteria, and fungi, establish self-sufficient microbial communities called “Biological Soil Crusts” (BSCs). A review of the current literature can be found in Belnap and Lange (2001). In arid ecosystems, BSCs are responsible for 99% of the nitrogen input, represent up to 80% of the living ground cover, improve the nutritional value of forage plants, improve water retention, and control erosion. However, following a disturbance, the BSC are slow to recover. Given the significance of microbiotic crusts to arid ecosystems, their rates of natural recovery is slow. In addition to mining, the desert southwest is experiencing disturbances due to livestock, increased population, recreational use, and fire. Estimates of recovery range from 3800 years in the Mojave Desert to five years in the Colorado Plateau of Utah. The five year estimate was based on controlled trampling experiments where the abundant inoculum source was no further than 25 cm from the disturbed soil. The variation in estimated recovery rates lies partly with the definition of “recovery”, depending on whether the definition is based on ecological function (eg nitrogen fixation) or floristic considerations. Other primary factors include the amounts of moisture, soil type, and proximity to inoculum.

### ENVIRONMENTAL SIGNIFICANCE

Cyanobacteria and “cyanolichens” are the primary source of fixed atmospheric nitrogen in arid ecosystems. Studies, in the western United States, have observed between 5 to 49 cyanobacterial taxa depending on the study site. Nostoc, Schizothrix, Anabaena, and Tolypothrix are the most frequently encountered heterocystous genera. Microcoleus and Phormidium are commonly encountered non-heterocystous genera. In western Colorado, for example, Scytonema, a heterocystous genus, is frequently observed. Heterocysts are differentiated specialized cells responsible for nitrogen fixation. Heterocysts lack the water-splitting O₂-evolving Photosystem II apparatus. This adaptation has evolved to eliminate the inhibition of nitrogenase activity by O₂, but still generates ATP energy by retaining photosystem-I activity.

Many non-heterocystous cyanobacterial genera are known to contain nitrogenase and may fix nitrogen in the dark under microaerophillic or anaerobic conditions. However, others have been unable to detect nitrogenase in the filamentous non-heterocystous species, Microcoleus vaginatus, via molecular, biochemical, and cultural techniques. Microcoleus vaginatus is an extremely important microbiotic crust component based on its frequency of occurrence and morphology. The mucilaginous encased filaments of Microcoleus vaginatus are highly effective in binding sand particles, thus reducing erosion and producing a stable substrate for the colonization of cyanolichens and other microorganisms. Although M. vaginatus may not fix nitrogen directly, it has been proposed that its mucilaginous sheath provides an anaerobic micro-environment and carbon source for epiphytic diazotrophic bacteria.

Cyanolichens are also a major contributor of fixed-nitrogen and microbiotic crust ground cover in desert ecosystems. Lichens are a mutualistic symbiosis between a fungus (mycobiont) and an alga (phycobiont). In most cases, the lichen phycobiont is a green alga, usually Trebouxia, but the cyanolichen phycobiont consists of cyanobacteria, most commonly Nostoc, Scytonema, or Anabaena. These cyanolichens are characteristically black, gelatinous in texture, and non-stratified. Certain stratified lichens inhabiting subalpine biomes, such as Peltigera and Lobaria, contain both the green Trebouxia, and the nitrogen-fixing cyanobacterium, Nostoc. For example, the cyanolichens of the arid western United States can occupy from 40 to 100% of the ground cover and make significant contributions towards soil stabilization and N₂-fixation. Depending on the soil and abiotic environment, up to 159 lichen species representing 53 genera have been observed. Some of the most commonly encountered genera include, Collema, Placinthium, Leptogium, and Heppia. Although many of the free-living cyanobacterial genera mentioned above are associated with these cyanolichens, it is currently unknown whether the same cyanobacterial species are strictly free living, strictly lichenized, or operate in either mode.

Biological soil crusts have been shown to enhance the establishment and growth of native vascular plants. Essential elements such as N, P, K, Ca, and Na are higher in plants grown in the presence of microbiotic crusts as determined from field and greenhouse studies. The improved mineral nutrition is attributed to concentration of the essential elements on the soil surface, increased soil temperature, chelating agents in the mucilaginous sheath, and the enhanced development of mycorrhizal fungi and rhizosphere bacteria.

The most limiting resource in arid ecosystems is water. Water drives the biogeochemical cycles, and most importantly, is the ultimate source of electrons of the energy cycle derived through photosynthesis. Microbiotic crusts account for up to 100% of the ground cover in plant interspaces and have been shown to improve water percolation by maintaining soil pores. Mature crusts in North American “cold deserts” will often develop a “pinnacled” structure that tends to retard the horizontal flow of water. The water holding capacity is also increased compared to bare soils because of the microbiotic crust's contribution of organic matter. Carbon productivity can range from 28 to 350 kg C ha⁻¹ yr⁻¹. The mucilaginous sheaths produced by the algae and associated fungi swell 13 fold by volume and perform chelating functions. This chelation activity has been shown to significantly enrich soil with exogenous micro-elements (Zn, Mo, Mn, Cu, etc.) obtained from Aeolian deposition. Furthermore, the filamentous morphology and secretion of mucilaginous polymers of several soil cyanobacteria bind sand particles making the cohesive units larger and heavier. This binding of soil particles, depending on the crust's developmental stage, has been shown to reduce wind erosion.

### DESCRIPTION OF PRIOR ART

In the patents, U.S. Pat. No. 3,889,418 and U.S. Pat. No. 3,958,364 there is disclosed methods for the production of polysaccharides by unicellular, eukaryotic algae, primarily Chlorella and Chlamydomonas, in order to facilitate soil aggregation and conditioning. Both Chlorella and Chlamydomonas are unicellular eukaryotic “green algae”, and are therefore incapable of fixing nitrogen. The two disclosures manipulated the nutrient composition of the medium in order to induce the production of the desired polysaccharides. Both methods make no special efforts to preserve or disseminate the algae. U.S. Pat. No. 3,889,418 and U.S. Pat. No. 3,958,364 are distinguished from each other by the composition of the medium and the apparatuses used to produce the algae.

U.S. Pat. No. 4,774,186 differentiates itself by describing a method for preserving the algae. This is accomplished by growing the in large vats that are supplied with light, gases and artificial mineral-salts medium. The algae are then concentrated by various means and preserved by mixing the thickened algal slurry with a dry dispersible carrier, preferably clay. In addition to exploiting Chlorella and Chlamydomonas, they disclose the idea of adding cyanobacteria as well. As an optional embodiment, they disclose the idea of mixing two or more algal strains, not species, after they have been produced separately. As another optional embodiment, that was neither claimed nor reduced to practice, disclosed the idea of drying globose algal species in the absence of a carrier with warm air. However, the literature teaches that the preferred algal species that cited by U.S. Pat. No. 4,774,186 do not survive the proposed drying process. These organisms, Chlorella and Chlamydomonas, were selected by the inventors for their ability to produce flocculating polymers and their ease of laboratory cultivation, not their ability to retain viability through repeated cycles of drying and hydration in the vegetative state. In nature, these organisms survive adverse conditions, such as desiccation, through the production of zygospores, which are resistant thick-walled cells that arise from the sexual recombination (plasmogamy and karyogamy) of two sexually compatible vegetative gametes. Given this analysis, it is difficult to believe that the proposed process of U.S. Pat. No. 4,774,186 would have any realistic chance for success.

In contrast, U.S. Pat. No. 4,879,232, U.S. Pat. No. 4,921,803, and U.S. Pat. No. 4,950,601 grow the algae (primarily cyanobacteria) in a 4 L flask where a cloth-like polymeric substrate is submerged in the liquid culture. Some of the algae adhere to the substrate that is subsequently removed, and the colonized substrate is applied to the soil. Alternatively, the algal slurry is applied to the substrate that may later receive additional polymeric layers prior to placing the immobilized algae on soil.

U.S. Pat. No. 6,228,136 differentiates itself from the previous three efforts (U.S. Pat. No. 4,879,232, U.S. Pat. No. 4,921,803, and U.S. Pat. No. 4,950,601) by immersing a cloth-like substrate in shallow 5-mm deep ponds containing an artificial mineral-salts medium. The immersed substrate is inoculated with cyanobacteria, preferably Microcoleus. The Microcoleus is allowed to grow on the moist substrate until a desired level of colonization is achieved. The colonized substrate is removed from the pond and it is allowed to dry for the purpose of preservation. The colonized substrate is either directly applied to the soil, or it is chopped prior to dissemination.

Despite the above-noted efforts, a cost effective and efficient method is still required for the production of cyanobacterial inoculants for the restoration of disturbed and agricultural landscapes.

### SUMMARY OF THE INVENTION

The problems illustrated by the foregoing disclosures are addressed by the present invention as will be described and illustrated in the following sections. The invention described herein is a method and means to accelerate the recovery of biological soil crust communities and consequently reestablish the native vascular flora. This invention describes how to isolate the important crust-forming nitrogen-fixing cyanobacteria from nature, cultivate them in a closed system apparatus, prepare them for long-term storage and then apply them to disturbed arid soils.

A main innovation of this invention is a unique method and means to isolate and produce a self-propagating, photosynthetic, nitrogen-fixing cyanobacterial inoculum native to a terrestrial substrate in need of restoration. This inoculum serves as a photosynthetic living biofertilizer that will facilitate the restoration of disturbed arid landscapes through erosion control and enhanced soil fertility. Since the biofertilizer is alive, it improves with age thus eliminating the need for additional applications of soil amendments.

The preparation of this inoculum is carried out in a photobioreactor that produced the cyanobacteria on a continuous basis as opposed to batch production. Another innovation of the present invention is the elimination of a substrate on which the inoculum is grown. This substantially increases the flexibility of the photobiofertilizer by allowing the product to be dispersed by all dispersion methods because there is no need to break down or grind up a carrier or substrate material. This invention also combines the method of production with a method of storing the inoculum using one or more of several drying technologies such as, for example, air-drying, spray-drying or refractance-window drying. In some instances, it may be desirable to preserve the algae in a frozen state. Another innovation of this invention is the unique combination of technologies to produce an inoculum that does not require the introduction foreign material to disturbed arid soils.

This technology is based on the manipulation of nitrogen-fixing cyanobacteria and the phycobionts of cyanolichens. These organisms fix atmospheric nitrogen to forms available to microbes and plants (NH₄⁺, NO₃⁻), and reduce erosion by stabilizing the soil and improving hydrological relationships. Further, they contribute significant levels of carbon to the soil that represents an energy source for the microorganisms involved in the biogeochemical cycles, P, S, N, K, Ca, etc., the elements essential to life. These organisms are photosynthetic (photoautotrophic) and will self-perpetuate in the presence of water, CO₂, and sun-light. The terrestrial cyanobacteria are also known to synthesize and secrete plant hormone substances that enhance vascular plant vigor. In addition, these cyanobacteria are known to withstand long periods of desiccation and intense sun-light. Given these attributes, it is not surprising that the cyanobacteria are the initial colonizers of new substrates in natural ecosystems. As a result, the cyanobacteria provide the substances and environments that promote the establishment of bacteria, fungi, lichens, bryophytes, invertebrate animals, and vascular plants.

The cyanobacterial genera to be exploited are obtained from biological soil crusts and include, but are not limited to the following genera: Nostoc, Anabaena, Scytonema, Tolypothrix, Calothrix, Microcoleus, Rivularia, Phormidium, Symploca, Schizothrix, Stigonema, Plectonema, and Chroococcus. In addition to these cyanobacteria, it may be desirable to include eukaryotic algae such as Chlamydomonas, Trebouxia, Scenedesmus, for instance. In many cases, it will be desirable to include free-living nitrogen-fixing bacteria, such as Azotobacter, Rhodospirillium, or Rhodopseudomonas, for example. Other important soil bacteria such Arthrobacter and various actinomycetes including the genera, Frankia, Nocardia, Streptomyces, and Micromonospora may be included to enhance nutrient cycling. Finally, it may be desirable to include lichenizing, saprophytic, and mycorrhizal fungi to complete the microbial complement of the basic photosynthetic biofertilizer. These heterotrophic microorganisms will be produced using standard methods.

Following the initial isolation, the cyanobacteria are introduced into a solar driven photobioreactor where the levels of nutrients, light, gases, and temperature are controlled to optimize the algal growth. The photobioreactor may be of tubular, plate, fiber-optic, immobilized cell, or biphasic design. Photobioreactors have the advantage over open systems because the growth conditions are controlled. In addition, photobioreactors also have a smaller footprint thus reducing land costs.

When the algal density in the photobioreactor reaches a desired density, a portion is removed and preserved. The cells remaining in the photobioreactor are re-circulated to serve as inoculum for the next cycle. The liquid volume that is removed is replaced by fresh medium to make a continuous process of algal harvest, introduction of fresh nutrients, cycling through the photostage, and harvest.

The biofertilizer is designed, in addition to providing soil nitrogen and carbon, to behave as an erosion control agent. In most cases, the biofertilizer alone will achieve the desired results. Based on the flexibility of the biofertilizer, it can be used in conjunction with traditional erosion control methods such as fibrous mulches and tackifiers thus enhancing the efficacy of these traditional products. For instance, hard-rock mine tailings, waste and overburden characteristically become acidic (pH<3) through the oxidation of sulfur by bacteria. These acidic environments inhibit seed germination, and exceeds the lower pH limit of cyanobacteria (pH<5). However, we have shown that when a layer of mulch is applied to the surface, it serves as a chemical insulator that permits seed germination and the growth of the biofertilizer. The plant roots penetrate into the nitrogen-deficient acidic mine tailings and continue to grow when nitrogen is supplied by the biofertilizer.

### BRIEF DESCRIPTION OF THE DRAWINGS

FIG. 1 is a complete view of the photobioreactor showing the major elements.

FIG. 2 is a detailed view of the probe arrays.

FIG. 3 is a detailed overhead view of the pump and tank assemblies.

FIG. 4 shows the soil nitrogen response following an 18 month treatment with four levels of the photobiofertilizer.

FIG. 5 shows the soil chlorophyll response following an 18 month treatment with four levels of the photobiofertilizer.

### DETAILED DESCRIPTION OF THE INVENTION

In describing the preferred embodiment of the invention, specific terminology will be used for the sake of clarity. It is not, however, intended that the invention be limited to the selected term and it is understood that each specific term includes all technical equivalents that accomplish a similar purpose of communication.

The method of the present invention consists of the following linked steps:
(1) Isolate the important photosynthetic biological soil crust microorganisms to produce a polyspecies culture that closely reflects the native microbial species composition.
(2) Cultivate the cyanobacteria in a semi-closed solar-driven photobioreactor, for example, under controlled conditions designed to maximize biomass productivity.
(3) Harvest the cyanobacteria by, for example, a simple gravity-driven sedimentation and filtration, clarification, or centrifugation.
(4) Preserve the cyanobacteria by, for example, using refractance window drying technology, or other methods such as air drying, spray drying, vacuum drying, or freezing such that the cells remain viable.
(5) Pulverize, flake, or powder the dried cyanobacteria to facilitate packaging, storage, shipment, and final dissemination of the biofertilizer.
(6) Disperse the cyanobacterial biofertilizer onto the desired landscape by various means such as for example, by spraying using ground-based or crop dusting equipment. The application of the inoculum may be carried out with or without current reclamation technologies in order to rapidly achieve the desired effect.
   Isolation from Nature

A one cm³ sample of soil perceived to contain crust forming microorganisms is added to 300 mL of a liquid medium such as BG11 or Bold's Basal Medium in a one liter glass container. The culture is illuminated with cool white florescent light at roughly 100 μE·m⁻²·s⁻¹ and supplied with gentle bubbling of air supplemented with 2% v/v CO₂. Visible growth usually becomes apparent after two weeks of incubation. The culture is then evaluated for species diversity at which point the culture is either expanded by increasing the culture volume, or the cells are preserved by air drying for later use.

### Photobioreactor

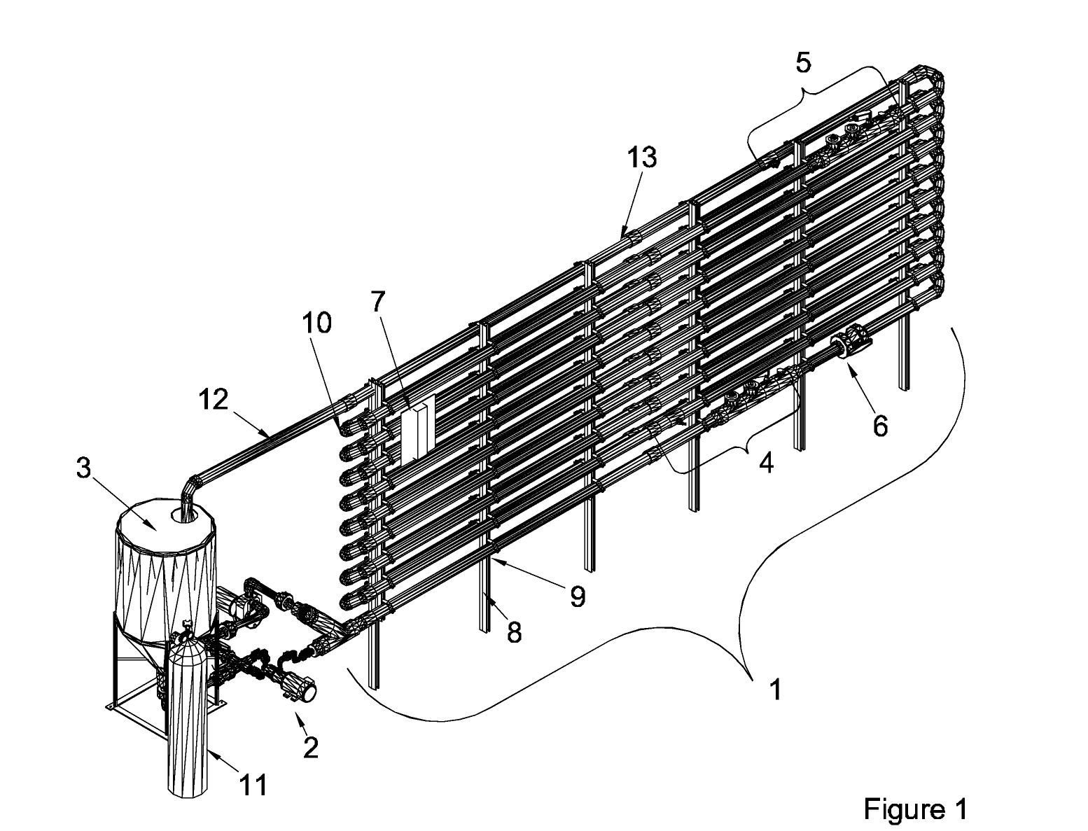

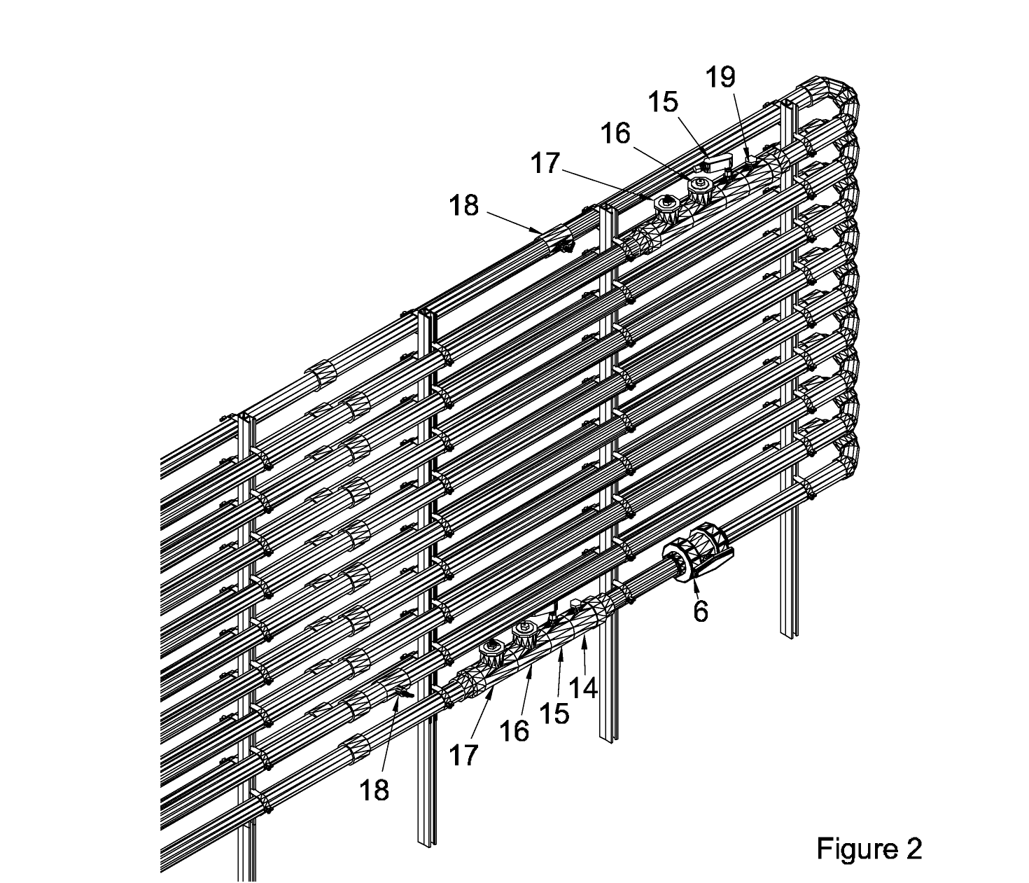

FIGS. 1, 2, and 3 show various aspects of a photobioreactor that may reside within a greenhouse. Citations of specific products are not intended to be an endorsement but are merely used for reference purposes only. The design disclosed here is a pilot-scale apparatus, and a commercial-scale photobioreactor of at least four times larger is the preferred embodiment, and can be constructed by increasing the photostage four-fold. The major elements of the pilot-scale photobioreactor are shown in FIG. 1. The photostage 1 is composed of 3 inch inner diameter schedule-40 clear polyvinyl chloride (PVC) pipe. In this case, two ten-foot sections are held together with a glued coupling 13 to make a horizontal run of 20 feet. The 90° corners are made with two 45° street elbows and a coupling 10. The coupling is unnecessary if belled ends are unavailable. The photostage dimensions for this particular configuration is 22×7.2 feet. The PVC pipe is supported by ten foot sections of double channeled steel posts 8 (Unistrut™ P-3300) and are held in place by 3⅝ inch OD clamps 9 (Unistrut™ P2051) that are compatible with the posts. The pipe is cushioned against the post and clamp with a strip of 3 mm neoprene wetsuit material.

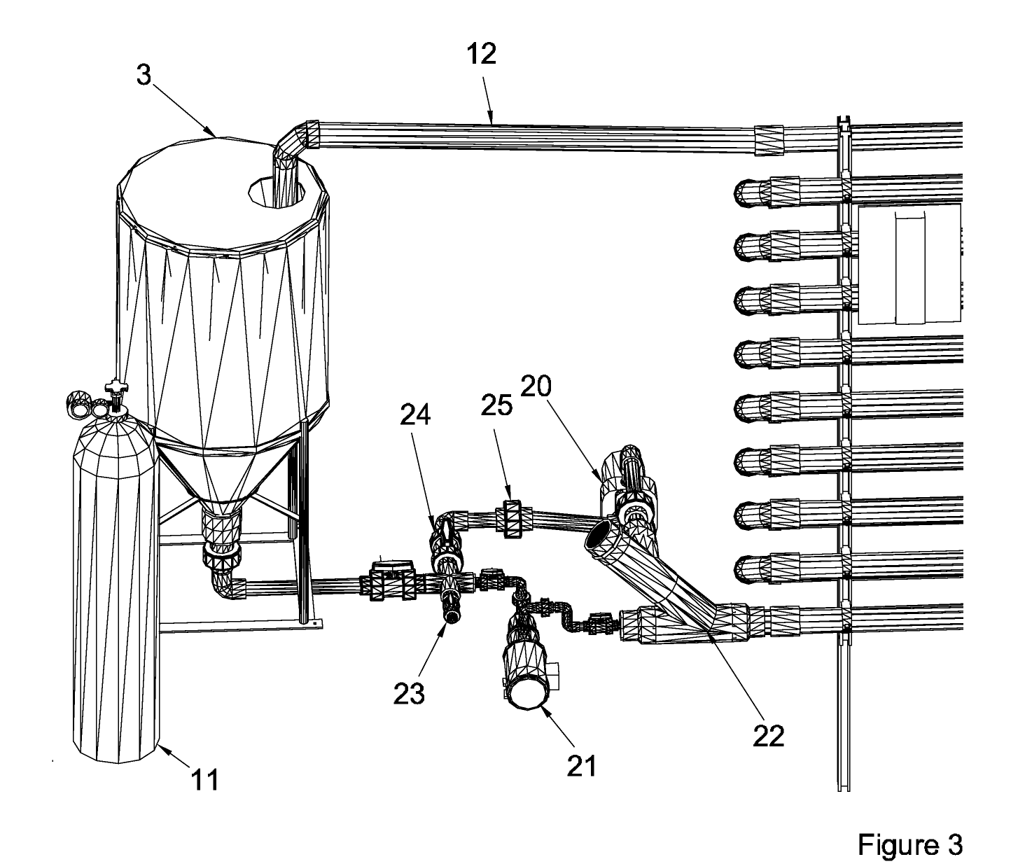

The pump assembly 2, detailed in FIG. 3, is composed of two pumps and a pig launcher. The circulation pump 21 (Moyno® model 34459) is a progressing cavity pump that is designed to circulate high solid slurries with low shear. The circulation pump is equipped with a variable field drive allowing for various circulation rates. The speed is currently set at 24 L·min⁻¹ to give a 16 minute residence time in the photostage 1. The photostage requires cleaning every two the three weeks when the adhering cells occlude light. The pig launcher 22 is composed of four inch ID PVC Tee fitting attached to a four inch ID 45° Wye fitting which is connected to the photostage with a 4″×3″ reducing fitting. The pig launcher is capped with a four inch threaded cleanout plug. The upstream portion 2 of the pig launcher is reduced to ¾″ to connect to the circulation pump 21 and the Tee fitting is reduced to two inches to connect to the “pig pump” 20. The pig pump is a self-priming centrifugal pump (OTS model 276B-95) normally used for irrigation and it is capable of pumping 60 GPM at 50 feet of head pressure. Two inch PVC pipe is used connect the pig pump to the Cross Tee 2 that connects the circulation pump and pig pump to the resting tank 3. Two inch unions 25 are included to facilitate servicing and a two inch valve 24 isolates the pig pump from the resting tank. A one inch product discharge valve 23 is connected to the Cross Tee. The last Cross Tee outlet 2 is reduced to ¾″ to connect the resting tank to the circulation pump. A ¾″ valve is placed between the Cross Tee and the circulation pump to isolate the pump from the resting tank.

The procedure for cleaning the system is as follows: The circulation pump is stopped and the lower tier of the photostage is isolated by closing the photostage valve 6 and the resting tank shutoff valve 2. The clean out plug is removed from the pig launcher 22, and a light density (1-2 LBS ft·3) polyurethane 3″ criss-cross pig (Girard Industries model YCC3) is inserted into the launcher. The cleanout plug is reinstalled and the isolation valves are opened. The pig pump is then activated and the pig is allowed to circulate through the system until it is discharged into the resting tank 3. The pig pump is then deactivated and power to the circulation pump is restored.

Water and inorganic salts are introduced into the system so that the level of the 110 gallon resting tank 3 is at 60 gallons when the photostage is full. This is accomplished by running the circulation pump 21 while filling with water. The working volume of the system is now 640 L. The inorganic nutrient composition can be varied to facilitate maximal growth rates, and many compositions such as BG-11 (Rippka, et al., 1979) have been published. The complete formulation for BG-11 is as follows: 17.6 mM NaNO₃, 172 μM K₂HPO₄, 304 μM MgSO₄.7H₂O, 245 μM CaCl₂.2H₂O, 16.1 μM Fe³⁺ delivered as ferric ammonium citrate, 3 μM EDTA, 189 μM Na₂CO₃, 46.2 μM H₃BO₃, 9.15 μM MnCl₂.4H₂O, 722 nM ZnSO₄.7H₂O, 1.61 μM Na₂MoO₄.2H₂O, 316 nM CuSO₄.5H₂O, and 170 nM Co(NO₃)₂.6H₂O. The formulation for BG-11 minus nitrogen eliminates the sodium nitrate. Following the addition of the inorganic salts, 20 L of an actively growing culture is introduced into the system. The culture, as stated above, is derived from native biological soil crust, and the species composition reflects the cyanobacterial community of the undisturbed crust usually including the genera Nostoc, Scytonema, Microcoleus, Trichormus, and others.

FIG. 3 details the gas shunt and probe arrays. Both the lower and upper probe arrays are expanded to four inch PVC tubing. This design permits free passage of the pig without damaging the probes. Element 17 is the gas collecting part of the gas shunt apparatus designed to keep gases from collecting on the probe surfaces. It is constructed from 4″×3″ slip-slip threaded Tee sealed with a 3×1″ threaded bushing that accepts 1″×½″ threaded-barbed elbow. Clear flexible ½″ ID tubing is attached to the hose barb is connected to the gas shunt receptacle 18 that is constructed from a 1″×½″ threaded-barbed elbow that is inserted in a 3″×1″ slip-slip threaded Tee. The dissolved oxygen probes 16 is inserted into a 4″×3″ slip-slip threaded Tee. The pH and temperature probes, 15 and 19 respectively, are inserted in 4″×1″ slip-slip threaded Tee's. An additional port 14 (4″×1″ slip-slip thread Tee) is included in the lower probe array.

The PT4 Monitor, supplied by Point Four Systems Inc. (Richmond, British Columbia Canada), includes the controller, acquisition software, dissolved oxygen, pH, and temperature probes (FIG. 3). The difference in dissolved oxygen between the lower 4 and upper 5 probe array provides a measure of photosynthesis. Likewise, the difference in pH between the lower and upper probe arrays is a measure of CO₂ consumption. Under illumination, the cells will photosynthesize and assimilate CO₂ causing the pH of the medium to rise. When the pH increases to a chosen set point, pH 7.5 in this instance, the controller will open a solenoid valve in order to introduce 100% CO₂ into the system. The CO₂ flow rate, controlled by a glass float rotameter, is currently set at 990 mL·min⁻¹. The rotameter and solenoid assembly 7 is mounted on a clear acrylic sheet (6″×12″¼″). The CO₂ tank and regulator 11 is connected to the rotameter assembly 7 using ⅛″ ID flexible tubing. The ⅛″ ID CO₂ delivery tubing then runs in parallel with the flexible 3″ ID reinforced PVC discharge tube 12 into the resting tank 3. The flexible CO₂ delivery tubing is then connected to a rigid ⅛″ ID acrylic tube of sufficient length to reach the bottom of the resting tank 3. A 90° elbow fitting is attached to the end of the rigid tubing and a 13 mm OD×15 cm ceramic diffuser (aquarium supply stores) is attached to the end of the CO₂ delivery system.

In the current system, the pH is held at 7.5, and the total alkalinity, or the ability to absorb protons, expressed as CaCO₃, was found to be 218 mg·L⁻¹ by titration and 13.3 mg·L⁻¹ of free CO₂. On bright sunny days the rate of photosynthetic oxygen evolution is about 520 μmoles O₂·mg Chl⁻¹·h⁻¹. This is estimated from the difference of dissolved oxygen from the beginning and end of the photostage, the residence time (16 min), and chlorophyll concentration.

In summary, the photostage 1 was constructed from clear schedule-40 PVC tubing (3″ ID) giving a total length of 100 m and a 415 L working volume. A progressing cavity low-shear circulation pump 21, placed between the photostage 1 and the resting-tank 3, circulates the culture to give a photostage residence time of 16 minutes. After the culture has circulated through the photostage, it is discharged into the resting tank (265 L working volume) where the excess oxygen is degassed to the atmosphere. Two sets of probes are used to measure dissolved oxygen, pH, and temperature at the beginning 4 and end 5 of the photostage. The difference in dissolved oxygen values at the beginning and end of the photostage measures the rate of photosynthesis. Likewise the difference in pH values measures the rate of CO₂ uptake. All of the probes are connected to a controller and the data is logged into a computer. In addition to the data acquisition, the controller holds the pH and dissolved CO₂ constant through control of a solenoid valve. When the solenoid valve is open, pure CO₂ is introduced into the beginning stage using a ceramic diffuser (13 mm OD×15 cm) at a rate of 990 mL min⁻¹.

Maintenance of the system is facilitated by the inclusion of a pig launcher 22 and high-volume centrifugal pig pump 20. In order to allow the free passage of the pig through the probe arrays, 4 and 5, the pipe is expanded to four inch ID fittings. The larger diameter creates a new problem by supplying a space for gas accumulation that would inhibit the proper operation of the probes. The problem is eliminated by the addition of the gas shunt system, 17 and 18. The gas collector 17 collects upstream gasses and dispenses the gas the upper tier gas receptacle 18. An earlier model lacking the expanded probe arrays required temporary removal of the probes to allow pigging. The newer and preferred design described here reduces maintenance time from one hour to seven minutes.

The cyanobacterial production rate of a polyspecies culture (TF115), on a dry weight basis, was roughly 1 Kg·month⁻¹. The photobioreactor was enclosed within a greenhouse glazed with 8 mm “twin wall” polycarbonate that allows 85% light transmission. The photobioreactor was illuminated with natural sunlight during the month of April at 39°04.387° north latitude In Grand Junction, Colo.

### Harvest and Preservation

The polyspecies cyanobacterial culture can be collected by two methods. The first and more primitive method entails stopping the circulation pump and allowing the cyanobacteria to settle. The sedimentation rate is about 3 cm·min⁻¹ and the algae are allowed to sediment for about 15 minutes. The product collection valve 23 is then opened the thick slurry is collected in a large container. This process removes about 75% of the free water. The thick slurry is dewatered further by filtration through polypropylene non-woven spun polyethylene fiber cloth that is placed in the bottom of a five gallon white plastic (high-density polyethylene) bucket that has a myriad of ⅛″ holes on ⅜″ centers drilled into the bottom. This filter apparatus resembles a large Buchner funnel. The free water is then removed by gravity filtration. Following the free water filtration, the algal biomass results in a soft custard-like cake that has the color and texture of cooked and pureed spinach. Further processing is explained below.

The second and preferred harvest method employs a centrifugal dairy clarifier. The shunt for the centrifugal separator is constructed adding a Tee fitting upstream from the circulation pump 21 and downstream of the circulation pump isolation valve (part of element 2) where an additional Tee fitting, downstream from the isolation valve, receives the clarified outflow from the centrifugal separator. The centrifugal separator is attached to both Tee fittings with flexible tubing. An additional valve is placed downstream from the centrifugal separator to isolate it from the photo stage.

The dewatered cyanobacterial cake is dried to air equilibrium by spreading the material to a thickness of 5 mm on a nylon screen framed with wood or window screening materials. The screens are stacked at four inch intervals and moving air at room temperature is applied using a fan. The free and cellular water is usually removed within 24 hours and results in hard dark-green flakes. The algal mass conversion on a dry to fresh weight basis is 7.7%+/−0.57% dry weight (n=20). The dehydrated cyanobacteria are further processed by grinding the material in a flour mill so that the particle size ranges from 10 μm to 50 μM in order to facilitate dispersal through a hydraulic spray apparatus.

The dried cyanobacterial biomass, as described above, retains viability following at least four years of storage in the dry state at room temperature. Pulverization of the dried photobiofertilizer produces a viable mixture, but it is the least desirable method because it reduces overall viability by mechanical damage to some of the cells. The mechanical damage problem can be avoided by extruding the moist photobiofertilizer through a die to produce small pellets or a powder that are dried using air drying, spray drying, or refractance-window drying.

The terrestrial cyanobacteria have evolved several adaptations that maintains membrane integrity and reduces photooxidation that permits their survival in harsh desert environments. The process of repeated dehydration and hydration of cyanobacteria is reviewed by Potts (1994). These terrestrial cyanobacteria withstand repeated cycles of hydration and dehydration in the natural environment. The cyanobacteria solve the problem of maintaining membrane integrity synthesizing membrane stabilizing proteins. In addition to membrane stability, the high solar input in arid terrestrial environments increases the rate of photooxidation with the production of highly reactive free radical species that can ultimately lead to cellular death. The solar input is reduced by the synthesis of a light absorbing compound called scytonemin. Scytonemin gives the characteristic black color of native crust communities, and this pigment works in the same way as suntan lotion. In addition, these cyanobacteria synthesize free radical scavengers, superoxide dismutase.

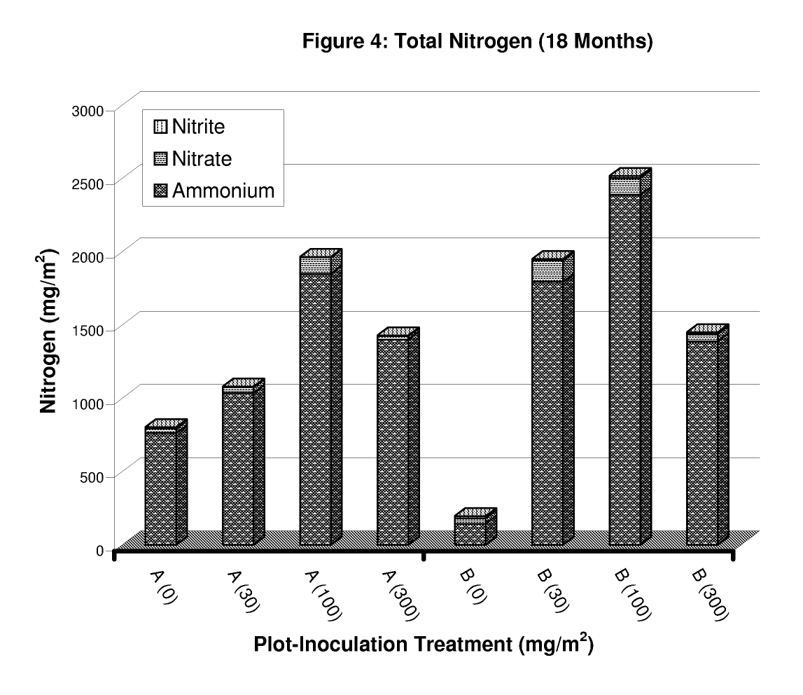

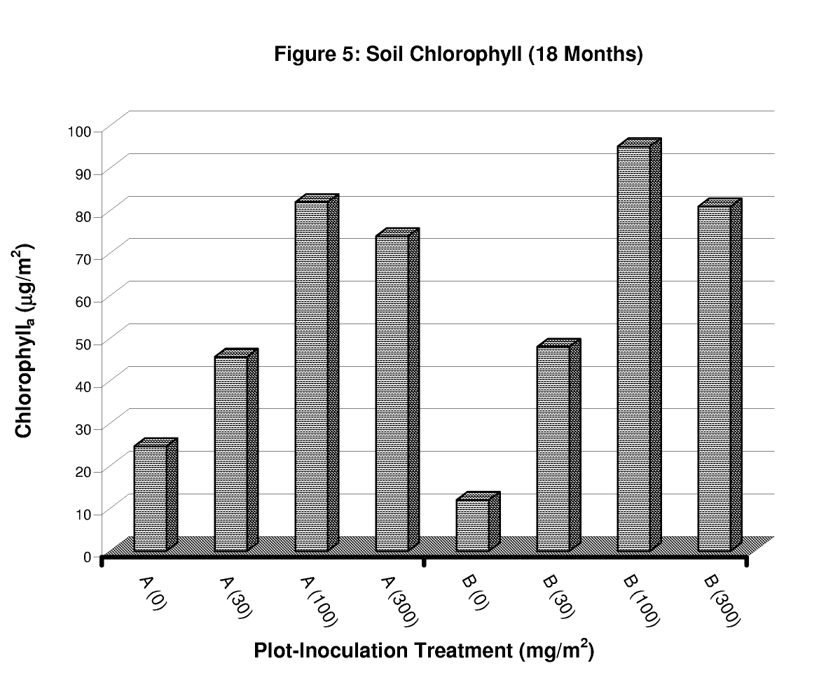

The currently employed preservation methods (air-drying and pulverization), produces a viable photobiofertilizer that improves soil fertility following the application to arid soils (see Table 1; FIGS. 4 and 5). To further increase the percentage of viable cells, a variety of additives designed to increase membrane stability and absorb free radicals can be added to the cyanobacterial mixture prior to the drying process. Examples of membrane stabilizers or “xeroprotectants” include but are not limited to sorbitol, mannitol, sucrose, sorbitan monostearate, glycerol, dimethyl sulfoxide, and methanol. These substances are added from 0.1% to 2.0% w/w or v/w basis to the moist photobiofertilizer cake that lacks free water. Examples of free radical scavengers include β-carotene (10 mg·kg⁻¹ slurry), β-mercaptoethanol (1 mmole·kg⁻¹ slurry), lycopene, astaxanthan, and mannitol. The mixing of both the xeroprotectants and free radical scavenger is expected to work synergistically to produce a more desirable effect.

### Deployment

A major advantage of the preservation process pertains to the flexibility of application. For instance, the dry algal powder can be applied by aircraft during the winter or wet seasons. Commercially available sprayers designed to disperse wettable powders, including backpack sprayers are the obvious choice. The reason for hydrating the biofertilizer is to improve soil adhesion to limit losses due to wind. In many situations, the biofertilizer alone will achieve the desired results of soil stabilization and fertilization. However, in cases where slope pitch requires traditional stabilization techniques such as using mulches and tackifiers, the biofertilizer will enhance the effectiveness of these products by contributing nitrogen and recruiting beneficial microorganisms.

### EXAMPLES

Several plots were installed on BLM public land known as the “Rabbit Valley Recreation Management Area”. It is located off exit #2 off I-70 30 miles west of Grand Junction, Colo. (39°11.812'N, 108°01.874'W). The elevation is 1430 m and the average precipitation is about 200 mm per year. Soil temperatures at the surface range from −20° C. to 60° C. The soils are alkaline with a pH around 8.2, and range from sandy to sandy-clay.

Historically, Rabbit Valley was a “sheep driveway” where at least 60,000 sheep were moved twice a year from summer to winter pasture. In addition to the overgrazing, the introduction of Bromus tectorum (Cheat Grass) has lead to hot destructive fires and displacement of the native flora. For example, undisturbed soils in Rabbit valley area are dominated by BSC, native perennial grasses including Oyzopsis, Stipa, and Hillaria, and the shrubs Sarcobatus and Atriplex, where these species represent over 90% of the living photosynthetic cover. Following the chronic disturbances, these native species have been displace by invasive exotic species that either increase the fire hazard (Bromus tectorum), lack nutritional value (Salsola), or is poisonous to wild life (Halogeton).

### Example 1

An inoculation experiment using fresh untreated photobiofertilizer was conducted from July 2003 to October 2004, to give 16 months of incubation in the field under ambient conditions. The experiment had two treatment levels of cyanobacterial inoculum, 0 and 500 mg·m⁻² on a dry mass basis. The values in Table 1 are based on four replicated measurements and are significantly different at the 99% level. The data in Table 1 show that soil inoculated with terrestrial cyanobacteria increased the total nitrogen content 12-fold compared to the control. The dominant species of nitrogen in the inoculated soils are NO₃⁻—N and NH₄⁺—N, with nitrate nitrogen being almost four-times greater than ammonium nitrogen, and the nitrite nitrogen is only 1.6% to the total nitrogen in the inoculated soil. The distribution of nitrogen species followed a different pattern in the uninoculated control soil. In this case the nitrate and nitrite nitrogen levels were about equal and represented 81% of the total nitrogen with only 19% being represented by ammonium nitrogen. The ammonium results are consistent with the fact that nitrogen secreted by cyanobacteria is in the form of ammonia.

Soil chlorophyll (Table 1) was used to estimate the presence of cyanobacteria. The detection limit of our equipment is 0.5 mg Chl·m² or 50 ng·cm², and the conversion from chlorophyll to dry biomass for cultured cyanobacteria is 2.59 μg Chl·mg⁻¹ cyanobacteria (dry weight). The chlorophyll assays show that cyanobacteria are absent in the uninoculated soil, and microscopic examination has failed to reveal a single cyanobacterial cell. The chlorophyll content of the inoculated soil, however, achieved about 20% of the chlorophyll content of well-established native cyanobacterial soil crusts (32 to 64 mg Chl·m⁻²) after only 18 months in the field. Further, our estimate of cyanobacterial biomass had increased almost ten-fold over the initial concentration. We find these results to be extremely encouraging given the current drought.

TABLE 1
Soil response to cyanobacterial inoculum (16 months under
ambient conditions)

Cyanobacterial
inoculation rate

| Parameter (mg · m⁻²) | 0 mg · m⁻² | 500 mg · m⁻² |
|---|---|---|
| NO₃⁻—N | 19.2 | 452 |
| NH₄⁺—N | 9.01 | 121 |
| NO₂⁻—N | 19.0 | 9.74 |
| Total Nitrogen | 47.3 | 583 |
| Soil Chlorophyll a | <0.5* | 12.4 |
| Algal Biomass | <0.193* | 4788 |

*less than the detection limits.

### Example 2

Two experimental plot arrays in the Rabbit Valley area were inoculated with the photobiofertilizer at four levels: 0, 30, 100, and 300 mg·m⁻² on a dry weight basis with each treatment location was randomly assigned. The 18 month incubation period under ambient natural conditions was from March 2005 to October 2006. FIG. 5 shows the soil nitrogen response to the various inoculation levels. For both treatment arrays A and B, the inoculated soils had significantly more nitrogen than the zero inoculation control. Ammonium is the dominant oxidation state followed by nitrate and a trace of nitrite. Newly fixed or “new” nitrogen occurs as ammonium, and this observation is consistent with the interpretation that this nitrogen was fixed by the cyanobacterial inoculant.

FIG. 6 shows the soil Chlorophylla response to the inoculation treatments of arrays A and B. As with the nitrogen, the treated plots had significantly more Chlorophylla than the untreated control. When comparing FIGS. 5 and 6, the nitrogen pattern mirrors the Chlorophylla pattern, and suggests that soil Chlorophylla is a good predictor on nitrogen fixation. It is curious however, that the nitrogen and Chlorophylla of the 100 mg·m⁻² treatments were greater than the 300 mg·m⁻² treatment for both arrays A and B. Also, in the case of array B, the 30 mg·m⁻² approaches the nitrogen and Chlorophyllₐ levels of the 100 mg·m⁻² treatment. This question can not be resolved at this point, but it appears that if sample collection error is disregarded, that the lower inoculation rate yield a greater response than the highest rate in this example.

### Appendix

The following publications are incorporated by reference herein:
Belnap, J., and Lange, O. L. (eds.), 2001. Biological Soil Crusts: Structure, Function, and Management. Ecological Studies 150, Springer-Verlag, Berlin. 503 pp.
Rippka, R., Deruelles, J., Waterbury, J. B., Herdman, M., and Stanier, R. Y. 1979. Generic assignments, strain histories and properties of pure cultures of cyanobacteria. Journal of General Microbiology 111:1-61.

The following patents are incorporated by reference herein:
U.S. Pat. No. 6,228,136 Riley, et al. Cyanobacterial inoculants for land reclamation.
U.S. Pat. No. 4,879,232 MacDonald, et al. The use of heterocystous blue-green algae as a fertilizer which fixes nitrogen.
U.S. Pat. No. 4,950,601 MacDonald, et al. The use of heterocystous blue-green algae as a fertilizer which fixes nitrogen.
U.S. Pat. No. 4,921,803 Nohr. The use of heterocystous blue-green algae as a fertilizer which fixes nitrogen.
U.S. Pat. No. 4,774,186 Schaefer Jr. et al. Include cyanobacteria to their list of algae and the use of an aqueous suspension comprising water, algae and a carrier which is sprayed on soil.
U.S. Pat. No. 3,889,418 Porter and Nelson 1975. A method for growing Chlorella pyrenoidosa in a liquid medium derived from a cow manure extract.
U.S. Pat. No. 3,958,364 Schneck, et al. 1976. The production of the flocculating polysaccharides by reducing the nitrogen concentration of the medium.

What is claimed is:

1. A method of making a photosynthetic soil inoculant (=photobiofertilizer), where the method comprises:
(a) isolating a cyanobacterial culture from a terrestrial biological soil crust community, wherein the soil inoculum comprises one or several cyanobacterial species;
(b) enriching the culture for the desired cyanobacteria in a liquid medium;
(c) mass-producing the soil inoculant in a photobioreactor; and
(d) inducing a dormant stage in the soil inoculant by dehydration.

2. The method of claim 1, wherein at least one of the cyanobacterial species fixes nitrogen.

3. The method of claim 1, wherein the photobioreactor is a tubular design, plate design, fiber-optic design, or immobilized cell design.

4. The method of claim 1, wherein a mixture of several cyanobacterial species are grown simultaneously in the photobioreactor.

5. The method of claim 1, wherein the physical and nutrient environment of the photobioreactor is controlled in order to enhance the mass production of the photobiofertilizer.

6. The method of claim 5, wherein the additives are selected from the group consisting of mineral salts that lack fixed nitrogen.

7. The method of claim 5, wherein the pH is controlled by carbon dioxide.

9. The method of claim 1, wherein the photobiofertilizer further comprises one or more additional microorganisms selected from the groups consisting of free-living nitrogen-fixing heterotropic bacteria, actinomycetes, photosynthetic bacteria, mycorrhizal or lichenizing fungi, and combinations thereof.

10. The method of claim 9, wherein the nitrogen-fixing heterotropic bacteria are selected from the Azobacteriaceae or Frankiaceae groups with examples consisting of Azotobacter, Frankia, or Arthrobacter.

11. The method of claim 9, wherein the photosynthetic bacteria are selected from the Rhodospirillales group with examples consisting of Rhodospirillium, Rhodopseudomonas, and Rhodobacter.

12. The method of claim 9, the mycorrhizal fungi belong to the Glomales, and the lichenizing fungi belong to the groups such as Collema, Peltigera, Psora, Heppia, and Fulgensia.

13. The method of claim 1, wherein the photobiofertilizer is made dormant by a technique selected from the group consisting of spray drying, refractance-window drying, solar drying, air drying, or freeze drying.

14. The method of claim 13, wherein the cell viability is greater than 50% following the induced dormancy.

15. The method of claim 13, wherein the photobiofertilizer is processed to obtain a desired particle size.

16. The method of claim 14, where xeroprotectant additives such as sorbitol, mannitol, sucrose, sorbitan monostereate, dimethyl sulfoxide, methanol, β-carotene, and β-mercaptoethanol are used to increase post drying viability.

17. The method of claim 1, where the photobiofertilizer is applied to soils or mineral substrates that one wishes to rehabilitate.

18. The method of claim 17, wherein the photobiofertilizer is applied hydraulically, or in the dehydrated state.

19. The method of claim 18, wherein the photobiofertilizer is applied in combination with an additive selected from the group consisting of fibrous, cellulosic mulch material, polymeric tackifiers, clays, geotextiles, and combinations thereof.

20. The method of claim 17, wherein the photobiofertilizer is applied in combination with the seeds of vascular plants.
